(19) United States
(12) Patent Application Publication
(10) Pub. No.: US 2003/0154131 A1
(43) Pub. Date: Aug. 14, 2003

(54) Food and drink order automation system

(76) Inventor: Robert Kin Tsang, Chicago, IL (US)

Correspondence Address: ROBERT TSANG, 1348 W. 31ST PL., TOWNHOUSE, CHICAGO, IL, 60608, US

(21) Appl. No.: 10/072,045

(22) Filed: Feb. 8, 2002

(51) Int. Cl. G06F 17/60

(52) U.S. Cl. 705/15

(57) ABSTRACT

The Food and Drink Order Automation System is an improvement to the existing restaurant order taking/placing system. The restaurant staff can communicate remotely without walking to the kitchen, bar or central station. The Food and Drink Order Automation System attempts to eliminate the walking time between the customer table and kitchen, bar and central stations. The wait staff can select and submit food and drink orders using the PDA handheld device(s) with a stylus by checking food and drink selection boxes displayed in a graphical user interface format. Any special requirements made by the customer can also be specified in text form in the table number comment's section.

### SPECIFICATION

The Food and Drink Order Automation system is comprised of a wireless handheld unit (PDA/Palm Pilot Type brand) that communicates with a wireless network. All codes for transmission and retrieval are within the scope of this patent. Order Entry and Order Notifications are displayed on the handheld carried by the waiter staff allowing them to remotely communicate with the kitchen and bar stations. This method eliminates the travel time (walking) between customer tables and station/kitchen/bar.

A) The waiter/waitress staff submits food/drink orders with a handheld unit (PDA/Palm Pilot Type brand/stylus).

B) The electronic signal (order entry) is sent via TCP/IP to the wireless network.

C) The data is sent to the wireless network (H) and orders are sorted/counted.

D) It is then displayed in the kitchen and bar screen.

E) Once orders are completed, the chef and/or bartender hits ‘Completed’ per order entry on screen or with keyboard.

F) The ‘Completed’ order status (Bar/Kitchen) will be sent to the waiter staff with a ‘Beep’.

G) The central station can display all open/close orders with the status for each. With or without interface to the existing system, receipts can be printed.

[image]

### CROSS-REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT

Not Applicable

### DISK APPENDIX

Not Applicable

### BACKGROUND OF INVENTION

The invention pertains to restaurant's food order computer systems. The Order Automation system revamps restaurant food and drinks ordering processes and procedures with a state of the art wireless technology. With this system, customer food and drink orders can be processed and delivered at a fraction of the time compared to traditional methods. Order Entry and Order Notifications are displayed on the handheld device carried by the wait staff thus allowing the wait staff to place food orders/receive notifications with the wireless transmitter. This method eliminates the travel time between table and station/kitchen/bar.

### BRIEF SUMMARY OF THE INVENTION

The presented invention relates to an improved food order placement system allowing a remote, interactive audiovisual communication between the wait staff and the kitchen/bar stations. The wait staff can remotely submit a food/drink order to the kitchen/bar stations without physically being there. Once the drink and/or food order are completed and ready to be delivered to the customer table, the kitchen/bar staff can send a electronic notification to the PDA handheld device(s) carried by the wait staff. The Order Automation system attempts to reduce the time spent traveling between customer tables and stations/kitchen/bar. When travel time is reduced, restaurant patrons receive food and drink orders much faster. Sheer sales volume increases when restaurant patrons get in/out of the restaurant in a shorter time slot. The restaurant patron's increased turnover rate generates higher revenue without affecting operating cost. The complete Food and Drink Order Automation System, if used properly, will not negatively affect the overhead or operating cost.

Traditional method:

Waiter/waitress take the customer food and drink order.

Go to the central station or kitchen/bar to submit the orders.

Wait for the kitchen bell to ring when food is ready and if for drinks, wait by the bar for the drink orders.

The traditional method requires waiting for orders to be completed and time spent walking between customer tables to bar/kitchen.

Order Automation method:

Wait staff carry a remote handheld device where orders can be transmitted upon entry, they will not need to walk to the kitchen and bar until the orders are ready.

The bartender and/or kitchen staff notifies the wait staff when orders are ready by touching the screen panel at their workstation.

The wait staff's remote handheld device will be “Beep” and be notified of the customer's order.

The table number, order status, order to delivery time duration, etc. are displayed on the wait staff's remote handheld device.

[image]

I. Displays the establishment's table number for food to table reference and status checks.

II. Indicates the food order status.

III. Click next will navigate the user to the next screen. The next screen allows the user (Wait staff) to enter the customer's food/drink orders.

IV. Displays the wait staffs name.

V. The wait staff can view, edit and delete food order in this screen.

VI. The customer's food order can contain special requests such as “Add Salt” and “Onions”. The kitchen staff will see the special request in a text box format at the kitchen's workstation.

VII. The wait staff can maintain the food/bar order using the command buttons. However once the food is in work-in-process, the wait staff will be notified for further action.

### DETAILED DESCRIPTION OF THE INVENTION

Assuming all necessary hardware existed in the market today, the invention is the tying of these units together thereby resulting in a state of the art Food Order taking /placing system. The codes developed for the existing hardware (PDA/Handheld, Desktop, wireless network) are within this patent.

Scope

All programming codes used for transmission and retrieval of food and drink orders. The application codes reside in the handheld device and network server. The codes (routines, lookups, event procedures, etc) are methods that contain food order entries, program maintenance capabilities, all GUI, interfaces to the existing system and the relating tables/database stored in the server. This includes the interfaces tied to the existing system and restaurant's general accounting system.

Hardware Requirement

Hand-held scanner/PDA (Palm Pilot type transmitter), undetermined brand/model.

Desktop PC -700 Mhz, 128 MB Ram, 20 Gig disk space

Wireless Network using TCP/IP for protocols-Not within this US patent scope.

Software (OS) Requirements

Windows NT, 2000, 98 or 95

Interfaces

The programmed PDA can be interfaced with current system (existing software packages). Using existing scanner/remote handheld device in the market. The scope covers all hardware/software enhancements, changes and/or modifications whether tangible and/or intangible in nature.

The PDA can be part of a whole system, which is part of the scope of this patent declaration. In this case the scope of this patent covers all of the enhancements, changes and/or modifications whether tangible and/or intangible in nature to the existing system.

Note: Please see previous sections for further process definition and scope identification.

What I claim as my invention is:

1. A food and drink order automation system used by the restaurant wait, kitchen and bar staff, said food order automation system comprising:
a. Programmed one or more PDA handheld units: The wireless units are used by the wait staff. As prescribed in claim 1.
b. A wireless network linked to the existing network server. The wireless network is the middleware between the existing/non-existing restaurant server and the remote PDA handheld devices. Order data transmissions and corresponding notifications to the PDA handheld units go through the wireless network. As prescribed in claim 1.
c. All programming codes written in C, C++, Java and/or MS Visual Basic used for interfaces between PDA handheld unit(s) and wireless network prescribed in item 1a and 1b above. As prescribed in claim 1.
d. All programming codes written in C, C++, Java and/or MS Visual Basic supporting the communication backbone used in the Food and Drink Order Automation system. As prescribed in claim 1.
e. All programming codes written in C, C++, Java and/or MS Visual Basic used for reporting and storing food/drink order entries, This includes database tables, queries, methods and database update programming. As prescribed in claim 1.
f. All security programming codes written in C, C++, Java and/or MS Visual Basic used for protecting against would-be hackers. This includes all database tables, queries and programming methods. As prescribed in claim 1.
g. Graphical user interfaces (GUI) displayed on the PDA handheld device so wait staff can select and place food items. As prescribed in claim 1.
h. Graphical user interfaces displayed on the kitchen, bar and central station screen. If one existed already, the orders submitted by the wait staff will displayed on the existing GUI. Otherwise the said system is to provide a GUI screen. As prescribed in claim 1.
i. All integration hardware enhancements and/or modifications made to the existing system to accept the Food and Drink Order Automation system as prescribe in claim 1.
